(19) United States
(12) Patent Application Publication
(10) Pub. No.: US 2016/0128340 A1
(43) Pub. Date: May 12, 2016

(54) Pest control formulation composed of Beauveria bassiana, Cold Pressed Neem Oil and Refined Pyrethrum Extract, and methods of making and using same

(71) Applicant: Luis Augusto Mazariegos-Hurtado, Pembroke Pines, FL (US)

(72) Inventor: Luis Augusto Mazariegos-Hurtado, Pembroke Pines, FL (US)

(21) Appl. No.: 14/536,637

(22) Filed: Nov. 9, 2014

(51) Int. Cl. A01N 65/12; A01N 65/00; A01N 65/26

(52) U.S. Cl. CPC A01N 65/12; A01N 65/26; A01N 65/00

(57) ABSTRACT

The present invention provide pesticidal compositions containing a pesticidal natural oil and/or a pesticidal botanical extract and/or a pesticidal natural fungal entomopathogen, that can be used to control pests by killing the pests, preventing or reducing feeding, preventing or reducing eclosion of their eggs, or the like. These composition exhibits effective or more rapid knockdown pesticidal activity, and synergistic pesticidal activity. Some embodiments can be used to control pests including insects and/or arachnids, including arthropods such as whiteflies. The pesticidal natural oil is neem oil, the pesticidal botanical extract is refined pyrethrum extract and the pesticidal natural fungal entomopathogen is Beauveria bassiana strain GHA.

### TECHNICAL FIELD

Some embodiments of the present invention pertain to compositions that can be used to control a variety of pests. Some embodiments of the present invention can be used to control arthropods, including insects and mites, and/or other pests. Some embodiments of the present invention can be used to control sucking and biting pests, including e.g. whiteflies, aphids, thrips, mites, psyllids, mealybugs, soft scales, leaf hoppers and plant hoppers, weevils, plant bugs, borers, leaf-feeding insects, scarab, leaf-feeding beetles, and disease transmitting insects of the order Diptera and subclass Acarina. Some embodiments of the invention pertain to methods of using compositions to control pests. Other embodiments of the invention pertain to methods of making compositions to control pests.

### BACKGROUND

Insects have evolved resistance to all types of insecticides including inorganics, DDT, cyclodienes, organophosphates, carbamates, pyrethroids, juvenile hormone analogs, chitin synthesis inhibitors, avermectins, neonicotinoids, and microbials. Resistance occurs in thirteen orders of insects, yet more than 90 percent of the arthropod species with resistant populations are either Diptera (35%), Lepidoptera (15%), Coleoptera (14%), Hemiptera (in the broad sense, 14%), or mites (14%). Agricultural pests account for 59 percent of harmful resistant species while medical and veterinary pests account for 41 percent. Many species have numerous resistant populations, each of which resists many insecticides. Statistical analyses suggest that for crop pests, resistance evolves most readily in those with an intermediate number of generations (four to ten) per year that feed either by chewing or by sucking on plant cell contents (see Karaa\check{g}aç).

Though it has been over 80 years since the first discovery of a major agricultural pest becoming resistant to a pesticide, it was not until the 1950s that most growers became familiar with pesticide resistance as a result of the widespread development of insect resistance to DDT (see Ankersmit). Since then, growers have come to expect the eventual loss of pesticide effectiveness because of resistance. By the mid-1980s, there were records of about 450 resistant species of insects and mites. Examples of resistance to chemical insecticides can be found for any given pest.

The Two-spotted spider mite, Tetranychus urticae, is a species of plant-feeding mite that is generally considered a pest. It is the most widely known member of the family Tetranychidae or spider mites. T. urticae is extremely polyphagous; it can feed on hundreds of plants. The rapid development of resistance in T. urticae is favored by its high reproductive potential, extremely short life cycle and arrhenotokous mating system (see Van Leeuwen et al).

A recent study revealed that most of the resistance mutations are spread worldwide, with remarkably variable frequencies. By sequencing a 1540 bp ace fragment, encompassing the resistance mutations and downstream introns in 139 T. urticae individuals from 27 countries, 6 susceptible and 31 resistant alleles which have arisen from at least three independent mutation events were identified. The frequency and distribution of these ace haplotypes varied geographically, suggesting interplay between different mutational events, gene flow and local selection (see Ilias et al).

The western flower thrips (Frankliniella occidentalis) is an important pest insect in agriculture. This species of thrips is native to the Southwestern United States but has spread to other continents, including Europe, Australia (where it was identified in May 1993), and South America via transport of infested plant material. It has been documented to feed on over 500 different species of host plants, including a large number of fruit, vegetable, and ornamental crops. F. occidentalis is difficult to control with insecticides because of its thigmokinetic behaviour and resistance to insecticides. Resistance to a number of different insecticides has been shown in many populations of F. occidentalis. This flower thrips has the potential of fast development of resistance owing to the short generation time, high fecundity, and a haplodiploid breeding system (see Jensen et al).

The silverleaf whitefly is considered an invasive species in all areas it inhabits in the United States as well as Australia, Africa, several European countries. Bemisia tabaci became a serious issue in crops across the southwestern United States and Mexico in the 1980s. Florida's poinsettia greenhouses were crippled by the pest beginning in 1986, and by 1991, the whitefly infestation had spread through Georgia, Louisiana, Texas, New Mexico, and Arizona to plague crop growers in California. California, the state that produces approximately 90% of the United States' winter vegetable crop, has incurred an estimated $500 million in crop damage due to silverleaf whitefly populations. Across the plant industry, this is thought to cost the state $774 million in private sector plant sales, 12,540 jobs, and $112.5 million in personal income. On a national scale, the United States has suffered crop and ornamental plant damages in excess of $1 billion (see Henneberry et al and Jetter et al).

Bemisia tabaci has developed a high degree of resistance to several chemical classes of insecticides throughout the world. Resistance to α-cypermethrin, bifenthrin, pirimiphos-methyl, endosulfan and imidacloprid have been reported for Bemisia tabaci. A Bemisia tabaci population collected in a floriculture greenhouse exhibited the highest resistance against all insecticides: at LC₅₀, resistance factors were 23-fold for bifenthrin, 80-fold for α-cypermethrin, 18-fold for pirimiphos-methyl, 58-fold for endosulfan and 730-fold for imidacloprid (see Roditakis et al).

Myzus persicae, known as the green peach aphid or the peach-potato aphid, is the most significant aphid pest of peach trees, causing decreased growth, shriveling of the leaves and the death of various tissues. It is also hazardous because it acts as a vector for the transport of plant viruses, such as potato virus Y and potato leafroll virus to members of the nightshade/potato family Solanaceae, and various mosaic viruses to many other food crops. Myzus persicae is a globally distributed crop pest with a host range of over 400 species including many economically important crop plants.

Work spanning over 40 years has shown that M. persicae has a remarkable ability to evolve mechanisms that avoid or overcome the toxic effect of insecticides with at least seven independent mechanisms of resistance described in this species to date [see Silva et al]. A study published in 2012, suggests strongly that insecticide resistance in M. persicae is more complex that has been described, with the participation of a broad array of resistance mechanisms. The sensitive genotype exhibited the highest transcriptional plasticity, accounting for the wide range of potential adaptations to insecticides that this species can evolve. In contrast, the multiply resistant genotype exhibited a low transcriptional plasticity, even for the expression of genes encoding enzymes involved in insecticide detoxification (see Bass et al).

Prevention of malaria is best achieved by controlling the mosquito vector which, today in Africa relies almost entirely on the use of residual insecticides inside the home. This is largely reliant on a single class of insecticides, the pyrethroids. Only pyrethroids can be used to treat bednets and, although four insecticide classes are approved by the World Health Organization, the vast majority of programmes spray with pyrethroids. An inevitable consequence of the scale up of malaria control has been the emergence of insecticide resistance in the Anopheles vectors. Pyrethroid resistance was first detected in Anopheles gambiae in West Africa in 1993 and remained relatively rare until the end of the twentieth century. But in the past 10 years reports of pyrethroid resistance in the major African malaria vectors have escalated. The treated bed nets, plus indoor spraying, have placed heavy selective pressure on all of the other insects that live in close association with people (see Hemingway et al, Mouatcho et al, Ranson et al, and Toé et al).

In addition to becoming ineffective, chemical control of these pests has other significant drawbacks. For example, the use of chemical pesticides presents the further disadvantages of polluting the environment, creating potential health hazards to agricultural workers and to consumers, detrimental effect of these chemicals on non-target species resulting in secondary pest outbreaks, and phytotoxic reaction by treated plants.

Because of the problems associated with the use of chemical pesticides, safer and more effective methods of control for insect pests are clearly needed. Although biological control agents are actively being sought after, to date no biological control agent has been commercially successful for the control of the wide spectrum of pests mentioned, namely, whiteflies, aphids, thrips, mites, psyllids, mealybugs, soft scales, leafhoppers and plant hoppers, weevils, plant bugs, borers, leaf-feeding insects, scarab and leaf-feeding beetles, at various stages of development including eggs, nymphs, larvae, pupae and adults, on all types of crops, and disease transmitting insects of the order Diptera and subclass Acarina.

The development of a broad spectrum biorational would reduce the need for many of the petrochemically based pesticides. By using fungi in combination with natural botanical extracts to control insect pests, the potential for resistance development is practically inconceivable, due to the multiple site multi modal action, which in turn, will stabilize many of the pest management programs. Also the combined active ingredients have synergistic activity when applied together, reducing significantly the amount of active ingredient needed, thus having minimal residue.

Currently, there are several methods of controlling economically important pests such whiteflies, aphids, thrips, mites, psyllids, mealybugs, soft scales, leafhoppers and plant hoppers, weevils, plant bugs, borers, leaf-feeding insects, scarab and leaf-feeding beetles, on all types of crops, and disease transmitting insects of the order Diptera and subclass Acarina. These methods fall into three broad categories—chemical, biological and botanical (biochemical).

Chemical methods are the most commonly used and entail the use of chemical pesticides. However, chemical pesticides can cause insect resistance, especially in pests that have short life cycles. Additionally, they pose risks to human health and cause environmental damage due to adverse effects on non-target insects and other animals. Also, chemical pesticides used for pest control are non-selective and kill other, beneficial insects in sprayed areas. In short, chemical pesticides can adversely affecting plant life or can upset insect population balances by killing predators or parasitic insects that naturally control the pest populations (see WHO).

Biological methods of controlling economically-important pests have become increasingly attractive as a less ecologically-destructive way of dealing with these insects. Biological methods exploit an insect's natural enemies and include using insect parasitoids, predators, and pathogens. Of the various ways to use an insect's natural enemies as biological control agents for that insect, one of the most common is mass multiplying pathogens such as bacteria or fungi and applying them to an affected area as a biopesticide. Organisms which have been under investigation as potential biopesticides include viruses, nematodes, protozoa, bacteria and fungi (see Chidawanyika et al, Rusch et al).

Botanical (biochemical) pesticides are substances of natural plant origin that control pests, but are relatively non-toxic to mammals. Two examples of such botanical insecticides are Neem oil and Pyrethrum Extract. Neem is a naturally occurring oil pesticide found in seeds from the neem tree and made of many components. Azadirachtin is the most common known active from solvent extracted neem extract. Cold pressed neem extract, on the other hand, also contains other terpenoids such as nimbin and salannin, which have also highly desirable insecticidal properties. They reduce insect feeding, act as a repellent and interfere with insect hormone systems, making it harder for insects to grow and lay eggs (see Ahmad et al, Ahmed et al, Gahukar, Gurusubramanian).

Another botanical extract, refined pyrethrum extract, is composed of pyrethrins which are six natural organic compounds derived from Chrysanthemum cinerariifolium and C. cineum that have potent insecticidal activity. Pyrethrins are neurotoxins that attack the nervous systems of all insects. When present in amounts not fatal to insects, they still appear to have an insect repellent effect. Pyrethrins are not persistent, being biodegradable, break down on exposure to light or oxygen, and decompose almost immediately in alkaline mediums, all of which are highly desirable characteristics to avoid resistance problems (see Schleier J J et al). In order to increase efficacy, Pyrethrins are usually mixed with synergists such as piperonyl butoxide (PBO) (see Tozzi).

### SUMMARY

Some embodiments of the present invention provide pesticidal compositions containing a pesticidal natural oil and/or a pesticidal botanical extract and/or a pesticidal natural fungal entomopathogen. Some embodiments can be used to control pests by killing the pests, preventing or reducing feeding, preventing or reducing eclosion of their eggs, or the like. Some embodiments exhibit effective or more rapid knockdown pesticidal activity, and synergistic pesticidal activity. Some embodiments can be used to control pests including insects and/or arachnids, including arthropods such as whiteflies.

In some embodiments, the pesticidal natural oil is cold pressed neem oil. In some embodiments, the pesticidal botanical extract is refined pyrethrum extract. In some embodiments, the pesticidal natural fungal entomopathogen is selected from the group consisting of: Aschersonia spp. Beauveria spp., Entomophthora spp., Hirsutella spp., Isaria spp., Lecanicillium spp., Metarhizium spp. Nomuraea spp., and Paecilomyces spp. In some embodiments, the pesticidal natural fungal entomopathogen is a Beauveria bassiana. In some embodiments, the pesticidal natural oil is neem oil, the pesticidal botanical extract is refined pyrethrum extract and the pesticidal natural fungal entomopathogen is Beauveria bassiana strain GHA.

In some embodiments, the combination of the natural pesticidal oil and/or pesticidal botanical extract, and/or the pesticidal natural fungal entomopathogen exhibits a synergistic level of pesticidal activity. In some embodiments, the combination of the pesticidal natural oil, the pesticidal botanical extract and the pesticidal natural fungal entomopathogen is effective as a pesticide wherein each of the pesticidal natural oil, the pesticidal botanical extract and pesticidal natural fungal entomopathogen are present at a concentration below the concentration at which the pesticidal natural oil or the pesticidal botanical extract or the pesticidal natural fungal entomopathogen would exhibit similar pesticidal activity if used alone. In some such embodiments, the pesticidal natural fungal entomopathogen is Beauveria bassiana strain GHA, the pesticidal natural oil is cold pressed neem oil and the pesticidal botanical extract is refined pyrethrum extract.

### BRIEF DESCRIPTION

Compositions useful for controlling pests are disclosed. In some embodiments, the composition includes a pesticidal natural oil, a pesticidal botanical extract and a pesticidal natural fungal entomopathogen. Methods of making and using the compositions are disclosed.

### BRIEF DESCRIPTION OF THE DRAWINGS

FIG. 1 shows the synergistic effect to cause a fast knockdown.

FIG. 2 shows the results of an example testing the ability of a composition in accordance with one embodiment of the invention to kill aphids.

FIG. 3 shows the results of an example testing the prevention of egg emergence composition in accordance with one embodiment of the invention.

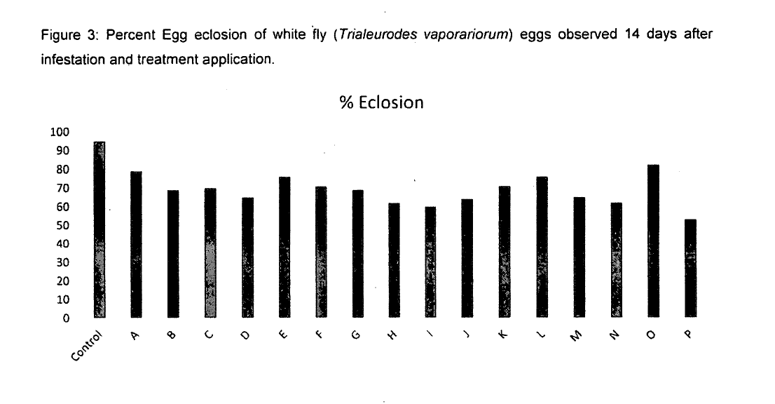

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Where a range of values is provided, it is understood that each intervening value, to the tenth of the unit of the lower limit unless the context clearly dictates otherwise, between the upper and lower limit of that range and any other stated or intervening value within that stated range is encompassed within embodiments of the invention. The upper and lower limits of these smaller ranges may independently define a smaller range of values, and it is to be understood that these smaller ranges are intended to be encompassed within embodiments of the invention, subject to any specifically excluded limit in the stated range.

Unless defined otherwise, all technical and scientific terms used herein have the same meaning as commonly understood by one of ordinary skill in the art to which this invention belongs. Although any methods and materials similar or equivalent to those described herein can also be used in the practice or testing of embodiments of the present invention, preferred methods and materials are described to avoid unnecessarily obscuring the disclosure.

As used herein, “comprises” or “comprising” are to be interpreted in their open-ended sense, i.e. as specifying that the stated features, elements, steps or components referred to are present, but not excluding the presence or addition of further features, elements, steps or components.

As used herein, singular forms include plural references unless the context clearly dictates otherwise. For example, “a fungus” also encompasses “fungi”.

As used herein, the term “pest” refers to organisms that negatively affect a host—such as a plant or an animal such as a mammal—by colonizing, damaging, attacking, competing with them for nutrients, or infecting them. This includes arthropods including insects and arachnids, and includes sucking and biting pests such as whiteflies, aphids, thrips, mites, psyllids, mealybugs, soft scales, leaf hoppers and plant hoppers, weevils, plant bugs, borers, leaf-feeding insects, scarab, leaf-feeding beetles, and disease transmitting insects of the order Diptera and subclass Acarina

As used herein, the term “pesticide” refers to an agent that can be used to control and/or kill a pest. The term is understood to encompass, but is not limited to, naturally occurring or synthetic chemical insecticides (larvicides, adulticides, ovicides), acaricides (miticides), fungicides, nematicides, parasiticides, or other control agents. “Pesticidal activity” refers to an agent that is active as a pesticide.

As used herein, the term “egg emergence” means eclosion; that is, the emergence of an adult insect from its pupal case or the hatching of an insect larva/nymph from an egg. “Preventing eclosion” or “preventing egg emergence” means preventing or delaying the emergence of an adult insect from its pupal case or the hatching of an insect larva from an egg.

As used herein, the terms “control” or “controlling” are meant to include, but are not limited to, any killing, growth regulating, or pestistatic (inhibiting or otherwise interfering with the normal life cycle of the pest) activities of a composition against a given pest. These terms include for example sterilizing activities which prevent the production of ova or sperm, cause death of sperm or ova, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, reducing gut motility, inhibiting the formation of chitin, disrupting mating or sexual communication, and preventing feeding (antifeedant) activity.

As used herein, a “pesticidal natural oil” is a natural oil or oils, for example derived from plant material, that exhibits pesticidal activity on its own. As used herein, “pesticidal natural oil” includes other materials derived, extracted or otherwise obtained from natural sources, for example, powdered extracts and the like. A “derivative” is a compound or composition that can be obtained from a natural oil. A “constituent” or “component” is a compound or composition found in a natural oil.

As used herein, “neem oil” refers to oil derived from the seeds, leaves, and bark of Azadirachta indica. Methods for obtaining neem oil, azadirachtin extract or other derivatives purified from neem oil are known in the art. One exemplary method for obtaining neem oil is cold pressing.

As used herein, “knockdown” activity refers to the pesticidal activity of a composition as applied directly to a pest.

As used herein, a “pesticidal botanical extract” is a natural extract or extracts, for example derived from plant material, that exhibits pesticidal activity on its own. As used herein, “pesticidal botanical extract” includes other materials derived, extracted or otherwise obtained from natural sources, for example, powdered extracts and the like. A “derivative” is a compound or composition that can be obtained from a natural extract. A “constituent” or “component” is a compound or composition found in a botanical extract.

As used herein, “refined pyrethrum extract” refers to extract derived from the flowers of Chrysanthemum cinerariifolium and C. cineum. Methods for obtaining refined pyrethrum extract are known in the art.

As used herein, a “pesticidal natural fungal entomopathogen” is a natural fungus, for example derived from infected insects, that exhibits pesticidal activity on its own. As used herein, a “pesticidal natural fungal entomopathogen” is an isolate from a natural source from the group consisting of but not limited to: Aschersonia spp. Beauveria spp., Entomophthora spp., Hirsutella spp., Isaria spp., Lecanicillium spp., Metarhizium spp. Nomuraea spp., and Paecilomyces spp.

As used herein, a “pesticidal natural fungal entomopathogen” is the natural fungus Beauveria bassiana. strain GHA. Methods for obtaining Beauveria bassiana spores are known in the art.

The term “carrier” as used herein refers to an inert material, organic or inorganic, with which an active ingredient can be mixed or formulated to facilitate its application, storage, transport, and/or handling. Commonly used carriers include, but are not limited to, mineral oil and vegetable oil. Exemplary carriers that can be used in some embodiments of the invention include inert carriers listed by the U.S. EPA as a Minimal Risk Inert Pesticide Ingredients (4A), Inert Pesticide Ingredients (4B) or under EPA regulation 40 CFR 180.950, each of which is hereby incorporated herein by reference in its entirety for all purposes.

Some embodiments of the present invention provide compositions and methods useful in the control of a variety of pests. Some embodiments of the present invention can be used to control insects, mites, and/or other pests. Some embodiments of the present invention can be used to control sucking and biting pests, including e.g. whiteflies, aphids, thrips, mites, psyllids, mealybugs, soft scales, leaf hoppers and plant hoppers, weevils, plant bugs, borers, leaf-feeding insects, scarab, leaf-feeding beetles, and disease transmitting insects of the order Diptera and subclass Acarina

In some embodiments, the composition includes a combination of a pesticidal natural oil, a pesticidal botanical extract and a pesticidal natural fungal entomopathogen. In some embodiments, the combination of the pesticidal natural oil, the pesticidal botanical extract and the pesticidal natural fungal entomopathogen is effective to control pests. In some embodiments, the combination of the pesticidal natural oil, the pesticidal botanical extract and the pesticidal natural fungal entomopathogen is effective to prevent eclosion. In some embodiments, the combination of the pesticidal natural oil, the pesticidal botanical extract and the pesticidal natural fungal entomopathogen exhibits effective knockdown pesticidal activity. In some embodiments, the combination of the pesticidal natural oil, the pesticidal botanical extract and the pesticidal natural fungal entomopathogen exhibits synergistic pesticidal activity.

In some embodiments, the combination of the pesticidal natural oil, the pesticidal botanical extract and the pesticidal natural fungal entomopathogen exhibits markedly improved ability to control pests and/or an expanded range of pesticidal activity as compared with either the pesticidal natural oil or the pesticidal botanical extract or the pesticidal natural fungal entomopathogen alone. In some embodiments, a composition including a combination of a pesticidal natural oil, a pesticidal botanical extract and a pesticidal natural fungal entomopathogen acts to prevent eclosion when used under conditions at which the pesticidal natural oil or the pesticidal botanical extract or the pesticidal natural fungal entomopathogen used alone would not prevent eclosion to a significant level. In some embodiments, a composition including a combination of a pesticidal natural oil, a pesticidal botanical extract and a pesticidal natural fungal entomopathogen exhibits improved or more rapid knockdown of a pest as compared with either the pesticidal natural oil or the pesticidal botanical extract or the pesticidal natural fungal entomopathogen used alone. In some embodiments, a composition including a combination of a pesticidal natural oil, a pesticidal botanical extract and a pesticidal natural fungal entomopathogen exhibits synergistic pesticidal activity as compared with either the pesticidal natural oil or the pesticidal botanical extract or the pesticidal natural fungal entomopathogen used alone.

In some embodiments, the pesticidal natural oil is cold pressed neem oil or a component or derivative thereof. In other embodiments, the pesticidal natural oil is any oil having as a constituent one of the following compounds, or a combination of the following compounds: azadirachtin, nimbin, nimbinin and salannin.

In some embodiments, the pesticidal botanical extract is refined pyrethrum extract or a component or derivative thereof. In other embodiments, the pesticidal botanical extract is any extract having as a constituent one of the following compounds, or a combination of the following compounds: pyrethrin I, pyrethrin II, cinerin I, cinerin II, jasmolin I, and jasmolin II.

In some embodiments, the pesticidal natural fungal entomopathogen is Beauveria bassiana or derivative thereof. In other embodiments, the pesticidal natural fungal entomopathogen is Beauveria bassiana strain GHA.

In some embodiments, a surfactant is used in preparing pesticidal compositions or pest control agents. Suitable surfactants can be selected by one skilled in the art. Examples of surfactants that can be used in some embodiments of the present invention include, but are not limited to, sodium lauryl sulfate, saponin, ethoxylated alcohols, ethoxylated fatty esters, alkoxylated glycols, ethoxylated fatty acids, carboxylated alcohols, carboxylic acids, fatty acids, ethoxlylated alkylphenols, fatty esters, sodium dodecylsulfide, other fatty acid-based surfactants, other natural or synthetic surfactants, and combinations thereof. In some embodiments, the surfactant(s) are non-ionic surfactants. In some embodiments, the surfactant(s) are ionic surfactants. The selection of an appropriate surfactant depends upon the relevant applications and conditions of use, and appropriate surfactants are known to those skilled in the art.

In some embodiments, a pesticidal composition includes a suitable carrier. A suitable carrier can be selected by one skilled in the art, depending on the particular application desired and the conditions of use of the composition. Commonly used carriers include mineral oil, vegetable oil and other inert carriers listed by the EPA as a Minimal Risk Inert Pesticide Ingredients (4A), Inert Pesticide Ingredients (4B) or under EPA regulation 40 CFR 180.950, each of which is hereby incorporated herein in its entirety for all purposes.

Some embodiments of the present invention include combinations of a pesticidal natural oil (and/or components and/or derivatives thereof) with a pesticidal botanical extract (and/or components and/or derivatives thereof) a pesticidal natural fungal entomopathogen and one or more other natural oils (plant, animal or mineral derived), synthetic oils, and/or chemical derivatives of any of the foregoing.

In some embodiments, a pesticidal composition comprises a pesticidal natural oil at a concentration of between 1% and 10% by weight, including any concentration therebetween e.g. 2%, 3%, 4%, 5%, 6%, 7%, 8% and 9% by weight; a pesticidal botanical extract at a concentration of between 0.25% and 1% by weight, including any concentration therebetween e.g. 0.3%, 0.4%, 0.5%, 0.6%, 0.7%, 0.8% and 0.9% by weight; and a pesticidal natural fungal entomopathogen at a concentration between 1×10⁶ to 1×10¹⁰ spores per ml, including any concentration therebetween e.g. 5×10⁶, 1×10⁷, 5×10⁷, 1×10⁶, 5×10⁶, 1×10⁹ or 5×10⁹ spores per ml.

Some embodiments of the present invention can be used to control pests such as arthropods, including insects and mites. Some embodiments of the present invention can be used to control insects or arthropods upon which they are expected to be effective based on their demonstrated activity, including, but not limited to, whiteflies, aphids, stink bug beetles, thrips, diamondback moths, leafminers, grasshoppers, crickets, locusts, leafhoppers, planthoppers, psyllids, scale insects, earworms, bollworms, armyworms, budworms, hornworms, mealy bugs, weevils, coffee bugs and vegetable bugs, and disease transmitting insects of the order Diptera and subclass Acarina. This disclosure is intended to encompass uses against all of the above, as well as uses against other pests, including other insects and mites.

In some embodiments, the pesticidal compositions described herein are effective to kill and/or control pests and/or prevent eclosion of their eggs, or exhibit improved knockdown of a pest, and/or synergistic pesticidal activity, when the concentration of each of the pesticidal natural oil, the pesticidal botanical extract and the pesticidal natural fungal entomopathogen is below a level at which the pesticidal natural oil, the pesticidal botanical extract and the pesticidal natural fungal entomopathogen used alone would be effective to achieve the same function. In some embodiments, the pesticidal compositions described herein exhibit a synergistic pesticidal effect as compared with the activity the pesticidal natural oil or the pesticidal botanical extract or the pesticidal natural fungal entomopathogen used alone. In some embodiments, the pesticidal compositions described herein exhibit significantly improved pesticidal effect as compared with the activity of the pesticidal natural oil or the pesticidal botanical extract or the pesticidal natural fungal entomopathogen used alone at the same concentration.

Some embodiments of the present invention can be used to control pests that affect plants or agriculture, such as aphids or whiteflies. In some embodiments, any of the compositions described above may be used in any situation in which a neem oil-based or pyrethrum extract based insect control agent is currently employed.

In some embodiments, any of the compositions described above are formulated in a deliverable form suited to a particular application. Deliverable forms that can be used in accordance with embodiments of the present invention include, but are not limited to, emulsions, fumigants, oily dispersions, and emulsifiable concentrates. Suitable deliverable forms can be selected and formulated by those skilled in the art using methods currently known in the art.

In some embodiments, any of the compositions described herein are applied outdoors or to plants or agricultural areas.

Some embodiments provide methods of using any of the compositions described above to control populations of whiteflies and/or other insects, mites and/or other arthropods. Some embodiments provide a method of killing and/or controlling pests and/or eclosion of their eggs by applying any of the compositions described herein directly to the pests or to surfaces where the pests or their eggs may contact the composition. In some embodiments, the pests are insects and/or mites. In some embodiments, the insects are of the orders hemiptera, thysanoptera, coleoptera, acarina or lepidoptera. In some embodiments, the pests are whiteflies and aphids.

Some embodiments of the present invention can be used in dispersible forms in agricultural or other outdoor settings to control pests.

Formulations according to some embodiments can be prepared in any suitable manner. Some embodiments of the present invention provide methods for preparing pesticidal formulations comprising mixing a pesticidal natural oil, a pesticidal botanical extract and a pesticidal natural fungal entomopathogen. The surfactant is added to the carrier oil to which the pesticidal natural oil and pesticidal botanical extract are added, and then pesticidal natural fungal entomopathogen is added to the liquid phase. Appropriate preservatives or stabilizers may optionally be added. Materials that encapsulate, hold, transport, delay release or otherwise improve delivery may optionally be added.

### EXAMPLES

Embodiments of the present invention are further described with reference to the following examples, which are intended to be illustrative and not limiting.

In the examples that follow, the pesticidal oil used was cold pressed neem seed oil; the pesticidal botanical extract was refined pyrethrum extract and the pesticidal fungal entomopathogen was Beauveria bassiana strain GHA.

### Example 1

### Insecticidal Knockdown Activity

This example illustrates the insecticidal knockdown activity of combinations of cold pressed neem oil with refined pyrethrum extract and Beauveria bassiana strain GHA against adult aphids, when compared with knockdown activity of Beauveria bassiana strain GHA alone, cold pressed neem oil alone and refined pyrethrum extract alone. Sixteen solutions were prepared: ‘Solution A’ included 1% cold pressed neem oil by weight, 0.25% refined pyrethrum extract and 1×10⁸ spores per ml Beauveria bassiana strain GHA, and 10% nonylphenol ethoxylate by weight; ‘Solution B’ included 1% cold pressed neem oil by weight, 0.5% refined pyrethrum extract and 1×10⁸ spores per ml Beauveria bassiana strain GHA, and 10% nonylphenol ethoxylate by weight; ‘Solution C’ included 2% cold pressed neem oil by weight, 0.25% refined pyrethrum extract and 1×10⁸ spores per ml Beauveria bassiana strain GHA, and 10% nonylphenol ethoxylate by weight; ‘Solution D’ included 2% cold pressed neem oil by weight, 0.5% refined pyrethrum extract and 1×10⁸ spores per ml Beauveria bassiana strain GHA, and 10% nonylphenol ethoxylate by weight; ‘Solution E’ included 1% cold pressed neem oil by weight, 0.25% refined pyrethrum extract and 5×10⁸ spores per ml Beauveria bassiana strain GHA, and 10% nonylphenol ethoxylate by weight; and ‘Solution F’ included 1% cold pressed neem oil by weight, 0.5% refined pyrethrum extract and 5×10⁸ spores per ml Beauveria bassiana strain GHA, and 10% nonylphenol ethoxylate by weight; ‘Solution G’ included 2% cold pressed neem oil by weight, 0.25% refined pyrethrum extract and 5×10⁸ spores per ml Beauveria bassiana strain GHA, and 10% nonylphenol ethoxylate by weight; ‘Solution H’ included 2% cold pressed neem oil by weight, 0.5% refined pyrethrum extract and 5×10⁸ spores per ml Beauveria bassiana strain GHA, and 10% nonylphenol ethoxylate by weight; ‘Solution I’ included the product having 1×10¹⁰ spores per ml Beauveria bassiana strain GHA and 10% nonylphenol ethoxylate by weight; ‘Solution J’ included the product having 1×10⁹ spores per ml Beauveria bassiana strain GHA and 10% nonylphenol ethoxylate by weight; ‘Solution K’ included 5% cold pressed neem oil by weight and 10% nonylphenol ethoxylate by weight; ‘Solution L’ included 10% cold pressed neem oil by weight and 10% nonylphenol ethoxylate by weight; ‘Solution M’ included 5% cold pressed neem oil by weight, 1×10⁹ spores per ml Beauveria bassiana strain GHA and 10% nonylphenol ethoxylate by weight; ‘Solution N’ included 10% cold pressed neem oil by weight, 1×10⁹ spores per ml Beauveria bassiana strain GHA and 10% nonylphenol ethoxylate by weight; ‘Solution O’ included 0.75% refined pyrethrum extract and 10% nonylphenol ethoxylate by weight; and ‘Solution P’ included 0.75% refined pyrethrum extract, 1×10⁹ spores per ml Beauveria bassiana strain GHA and 10% nonylphenol ethoxylate by weight.

Adult aphids were infested on to lettuce leafs. Aphids were treated by applying a solution containing 2.5 ml per liter of water of each solution. Mortality was assessed at 24 hours after treatment. Aphids were counted dead if unresponsive when stimulated. The percentage of dead adult aphids was calculated and compared to data from all other formulations. Table 1 summarizes mortality data of respective formulations at the stated interval.

TABLE 1
Insecticidal knockdown

| Treatment | | 24 HAT |
|---|---|---|
| 1 | Untreated check | 2.0% |
| 2 | Solution A (Nm 1% - Py 0.25% - Bb 1e8 sp/ml) | 36.0% |
| 3 | Solution B (Nm 1% - Py 0.5% - Bb 1e8 sp/ml) | 52.0% |
| 4 | Solution C (Nm 2% - Py 0.25% - Bb 1e8 sp/ml) | 46.0% |
| 5 | Solution D (Nm 2% - Py 0.5% - Bb 1e8 sp/ml) | 58.0% |
| 6 | Solution E (Nm 1% - Py 0.25% - Bb 5e8 sp/ml) | 30.0% |
| 7 | Solution F (Nm 1% - Py 0.5% - Bb 5e8 sp/ml) | 72.0% |
| 8 | Solution G (Nm 2% - Py 0.25% - Bb 5e8 sp/ml) | 64.0% |
| 9 | Solution H (Nm 2% - Py 0.5% - Bb 5e8 sp/ml) | 76.0% |
| 10 | Solution I (Bb 100 sp/ml) | 36.0% |
| 11 | Solution J (Bb 1e9 sp/ml) | 26.0% |
| 12 | Solution K (Nm 5%) | 16.0% |
| 13 | Solution L (Nm 10%) | 20.0% |
| 14 | Solution M (Nm 5% - Bb 1e9 sp/ml) | 50.0% |
| 15 | Solution N (Nm 10% - Bb 1e9 sp/ml) | 68.0% |
| 16 | Solution O (Py 0.75%) | 48.0% |
| 17 | Solution P (Py 0.75% - Bb 1e9 sp/ml) | 78.0% |

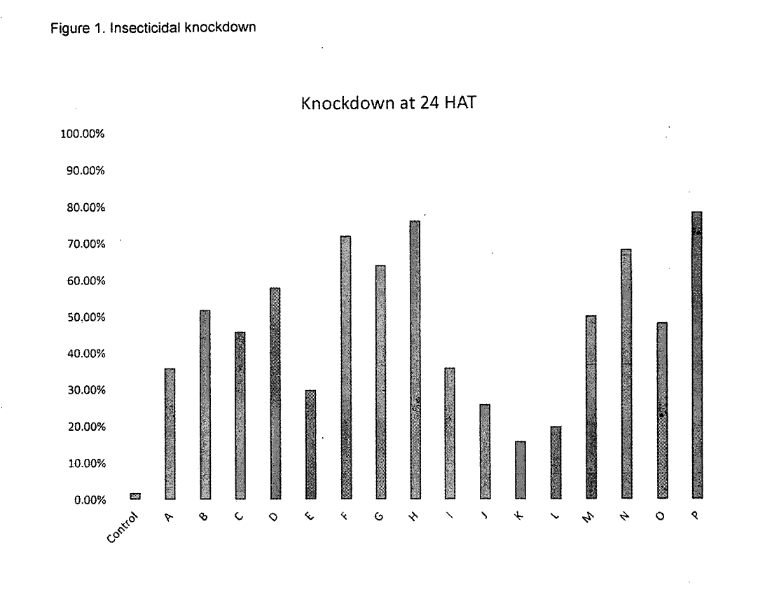

Knockdown mortality results at 24 hours after treatment (HAT) demonstrate that the concentration of Beauveria bassiana GHA strain spores, pyrethrum extract and cold press neem (Solutions F, G and H) can be reduced significantly and still comparable results as those of Beauveria bassiana and cold press neem (Solution N) and Beauveria bassiana and pyrethrum extract (Solution P) combinations. Even at levels as low as 0.94 ppm cold pressed neem oil, 6.25 ppm refined pyrethrum extract and 2.5×10⁹ spores/ml of Beauveria bassiana strain GHA in the spray solution, the combination demonstrated significant knockdown activity over an untreated control group. Results are summarized in FIG. 1.

### Example 2

### Pesticidal Activity

This example illustrates the pesticidal activity of combinations of cold pressed neem oil with refined pyrethrum extract and Beauveria bassiana strain GHA against adult aphids, when compared with pesticidal activity of Beauveria bassiana strain GHA alone, cold pressed neem oil alone and refined pyrethrum extract alone. Sixteen solutions were prepared: ‘Solution A’ included 1% cold pressed neem oil by weight, 0.25% refined pyrethrum extract and 1×10⁸ spores per ml Beauveria bassiana strain GHA, and 10% nonylphenol ethoxylate by weight; ‘Solution B’ included 1% cold pressed neem oil by weight, 0.5% refined pyrethrum extract and 1×10⁸ spores per ml Beauveria bassiana strain GHA, and 10% nonylphenol ethoxylate by weight; ‘Solution C’ included 2% cold pressed neem oil by weight, 0.25% refined pyrethrum extract and 1×10⁸ spores per ml Beauveria bassiana strain GHA, and 10% nonylphenol ethoxylate by weight; ‘Solution D’ included 2% cold pressed neem oil by weight, 0.5% refined pyrethrum extract and 1×10⁸ spores per ml Beauveria bassiana strain GHA, and 10% nonylphenol ethoxylate by weight; ‘Solution E’ included 1% cold pressed neem oil by weight, 0.25% refined pyrethrum extract and 5×10⁸ spores per ml Beauveria bassiana strain GHA, and 10% nonylphenol ethoxylate by weight; and ‘Solution F’ included 1% cold pressed neem oil by weight, 0.5% refined pyrethrum extract and 5×10⁸ spores per ml Beauveria bassiana strain GHA, and 10% nonylphenol ethoxylate by weight; ‘Solution G’ included 2% cold pressed neem oil by weight, 0.25% refined pyrethrum extract and 5×10⁸ spores per ml Beauveria bassiana strain GHA, and 10% nonylphenol ethoxylate by weight; ‘Solution H’ included 2% cold pressed neem oil by weight, 0.5% refined pyrethrum extract and 5×10⁸ spores per ml Beauveria bassiana strain GHA, and 10% nonylphenol ethoxylate by weight; ‘Solution I’ included the product having 1×10¹⁰ spores per ml Beauveria bassiana strain GHA and 10% nonylphenol ethoxylate by weight; ‘Solution J’ included the product having 1×10⁹ spores per ml Beauveria bassiana strain GHA and 10% nonylphenol ethoxylate by weight; ‘Solution K’ included 5% cold pressed neem oil by weight and 10% nonylphenol ethoxylate by weight; ‘Solution L’ included 10% cold pressed neem oil by weight and 10% nonylphenol ethoxylate by weight; ‘Solution M’ included 5% cold pressed neem oil by weight, 1×10⁹ spores per ml Beauveria bassiana strain GHA and 10% nonylphenol ethoxylate by weight; ‘Solution N’ included 10% cold pressed neem oil by weight, 1×10⁹ spores per ml Beauveria bassiana strain GHA and 10% nonylphenol ethoxylate by weight; ‘Solution O’ included 0.75% refined pyrethrum extract and 10% nonylphenol ethoxylate by weight; and ‘Solution P’ included 0.75% refined pyrethrum extract, 1×10⁹ spores per ml Beauveria bassiana strain GHA and 10% nonylphenol ethoxylate by weight.

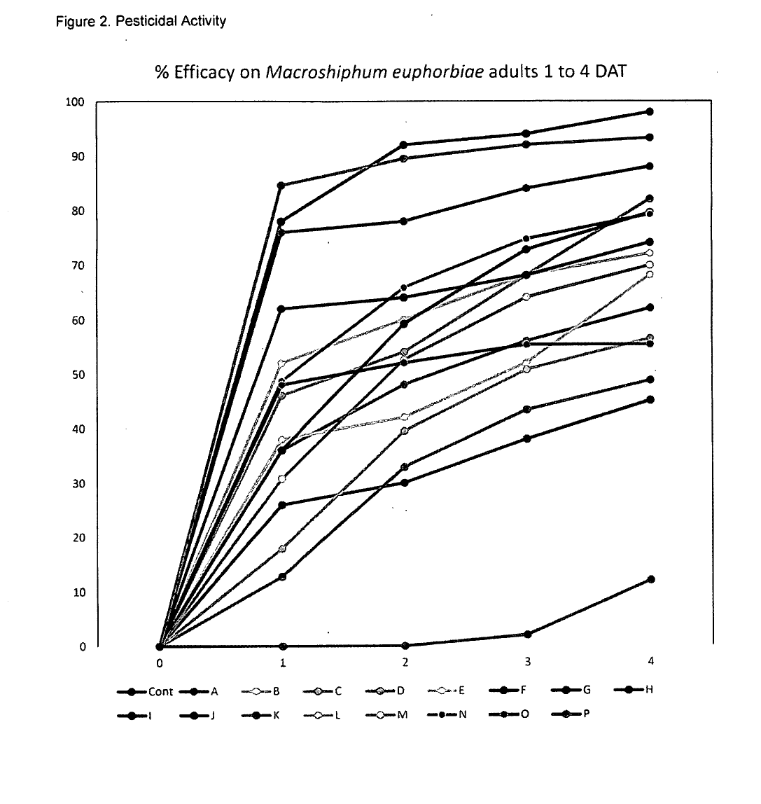

The percentage of dead aphids was measured at 1, 2, 3 and 4 days after treatment (DAT) and compared against controls. The data collected are summarized in Table 2 and results graphed in FIG. 2. Results demonstrate that the concentration of Beauveria bassiana GHA strain spores, pyrethrum extract and cold press neem (Solutions E, F, G and H) can be reduced significantly and still comparable results as those of Beauveria bassiana and cold press neem (Solutions M and N) and Beauveria bassiana and pyrethrum extract (Solution P) combinations. Even at levels as low as 0.94 ppm cold pressed neem oil, 6.25 ppm refined pyrethrum extract and 2.5×10⁵ spores/ml of Beauveria bassiana strain GHA in the spray solution, the combination demonstrated significant knockdown activity over an untreated control group. Results are summarized in FIG. 1. All treatments containing Beauveria bassiana showed mycosed insects at 4 DAT.

TABLE 2
Pesticidal Activity.

| | Efficacy (%) | | | |
|---|---|---|---|---|
| | Days after treatment (DAT) | | | |
| Treatment | 1 | 2 | 3 | 4 |
| Untreated Check | 0 | 0 | 2 | 12 |
| Solution A | 36 | 48 | 56 | 62 |
| Solution B | 52 | 60 | 68 | 72 |
| Solution C | 46 | 54 | 68 | 82 |
| Solution D | 38 | 42 | 52 | 68 |
| Solution E | 54 | 58 | 74 | 80 |
| Solution F | 78 | 92 | 94 | 98 |
| Solution G | 62 | 64 | 68 | 74 |
| Solution H | 76 | 78 | 84 | 88 |
| Solution I | 36 | 59 | 73 | 80 |
| Solution J | 26 | 30 | 38 | 45 |
| Solution K | 13 | 33 | 43 | 49 |
| Solution L | 18 | 40 | 51 | 56 |
| Solution M | 31 | 53 | 64 | 70 |
| Solution N | 49 | 66 | 75 | 79 |
| Solution O | 48 | 52 | 55 | 55 |
| Solution P | 85 | 90 | 92 | 93 |

### Example 3

### Prevention of Egg Emergence

This example illustrates the prevention of egg emergence of combinations of cold pressed neem oil with refined pyrethrum extract and Beauveria bassiana strain GHA against whiteflies, when compared with pesticidal activity of Beauveria bassiana strain GHA alone, cold pressed neem oil alone and refined pyrethrum extract alone. Sixteen solutions were prepared: ‘Solution A’ included 1% cold pressed neem oil by weight, 0.25% refined pyrethrum extract and 1×10⁸ spores per ml Beauveria bassiana strain GHA, and 10% nonylphenol ethoxylate by weight; ‘Solution B’ included 1% cold pressed neem oil by weight, 0.5% refined pyrethrum extract and 1×10⁸ spores per ml Beauveria bassiana strain GHA, and 10% nonylphenol ethoxylate by weight; ‘Solution C’ included 2% cold pressed neem oil by weight, 0.25% refined pyrethrum extract and 1×10⁸ spores per ml Beauveria bassiana strain GHA, and 10% nonylphenol ethoxylate by weight; ‘Solution D’ included 2% cold pressed neem oil by weight, 0.5% refined pyrethrum extract and 1×10⁸ spores per ml Beauveria bassiana strain GHA, and 10% nonylphenol ethoxylate by weight; ‘Solution E’ included 1% cold pressed neem oil by weight, 0.25% refined pyrethrum extract and 5×10⁸ spores per ml Beauveria bassiana strain GHA, and 1.0% nonylphenol ethoxylate by weight; and ‘Solution F’ included 1% cold pressed neem oil by weight, 0.5% refined pyrethrum extract and 5×10⁸ spores per ml Beauveria bassiana strain GHA, and 10% nonylphenol ethoxylate by weight; ‘Solution G’ included 2% cold pressed neem oil by weight, 0.25% refined pyrethrum extract and 5×10⁸ spores per ml Beauveria bassiana strain GHA, and 10% nonylphenol ethoxylate by weight; ‘Solution H’ included 2% cold pressed neem oil by weight, 0.5% refined pyrethrum extract and 5×10⁸ spores per ml Beauveria bassiana strain GHA, and 10% nonylphenol ethoxylate by weight; ‘Solution I’ included the product having 1×10¹⁰ spores per ml Beauveria bassiana strain GHA and 10% nonylphenol ethoxylate by weight; ‘Solution J’ included the product having 1×10⁹ spores per ml Beauveria bassiana strain GHA and 10% nonylphenol ethoxylate by weight; ‘Solution K’ included 5% cold pressed neem oil by weight and 10% nonylphenol ethoxylate by weight; ‘Solution L’ included 10% cold pressed neem oil by weight and 10% nonylphenol ethoxylate by weight; ‘Solution M’ included 5% cold pressed neem oil by weight, 1×10⁹ spores per ml Beauveria bassiana strain GHA and 10% nonylphenol ethoxylate by weight; ‘Solution N’ included 10% cold pressed neem oil by weight, 1×10⁹ spores per ml Beauveria bassiana strain GHA and 10% nonylphenol ethoxylate by weight; ‘Solution O’-included 0.75% refined pyrethrum extract and 10% nonylphenol ethoxylate by weight; and ‘Solution P’ included 0.75% refined pyrethrum extract, 1×10⁹ spores per ml Beauveria bassiana strain GHA and 10% nonylphenol ethoxylate by weight.

Whiteflies eggs laid on tomato leafs (each group with 40 eggs) were sprayed directly with 2.5 ml per liter of each solution. Five replicates for each of the Treated Groups and five negative Control Group were tested concurrently. At a 14 day interval, the number of hatched and unhatched eggs present were counted and compared to other Treated Groups and the untreated Control Group. One egg was counted as “hatched” for every new nymph present.

While the eggs in the Control Group hatched at the predicted interval of approximately 10 to 14 days, eggs in the Treated Groups were significantly impaired by experiment's end 14 days post-treatment. Table 3 shows the egg emergence data of the treated groups at the stated daily intervals as compared to the Untreated Control.

TABLE 3
Percent Egg eclosion of white fly (Trialeurodes vaporariorum) eggs
observed 14 days after infestation and treatment application.

| Treatment | | 15 DAA |
|---|---|---|
| 1. | Untreated check | 95 |
| 2. | Solution A (Nm 1% - Py 0.25% - Bb 1e8 sp/ml) | 79 |
| 3. | Solution B (Nm 1% - Py 0.5% - Bb 1e8 sp/ml) | 69 |
| 4. | Solution C (Nm 2% - Py 0.25% - Bb 1e8 sp/ml) | 70 |
| 5. | Solution D (Nm 2% - Py 0.5% - Bb 1e8 sp/ml) | 65 |
| 6. | Solution E (Nm 1% - Py 0.25% - Bb 5e8 sp/ml) | 76 |
| 7. | Solution F (Nm 1% - Py 0.5% - Bb 5e8 sp/ml) | 71 |
| 8. | Solution G (Nm 2% - Py 0.25% - Bb 5e8 sp/ml) | 69 |
| 9. | Solution H (Nm 2% - Py 0.5% - Bb 5e8 sp/ml) | 62 |
| 10. | Solution I (Bb 1e10 sp/ml) | 60 |
| 11. | Solution J (Bb 1e9 sp/ml) | 64 |
| 12. | Solution K (Nm 5%) | 71 |
| 13. | Solution L (Nm 10%) | 76 |
| 14. | Solution M (Nm 5% - Bb 1e9 sp/ml) | 65 |
| 15. | Solution N (Nm 10% - Bb 1e9 sp/ml) | 62 |
| 16. | Solution O (Py 0.75%) | 82 |
| 17. | Solution P (Py 0.75% - Bb 1e9 sp/ml) | 53 |

Various references are mentioned or pertinent to the discussion herein, including for example the References listed.

### REFERENCES

Application Number: 14494199 Pest control formulation of Neem and Beauveria bassiana and methods of making and using same. New Application Under 35 U.S.C. 111. EFS ID: 20222490. Sep. 23, 2014.
Patent EP2763541 A1 Pest control formulations and methods of making and using same
Patent WO1996039034 A1 (U.S. Pat. No. 5,679,662) Synergistic use of azadirachtin and pyrethrum
Patent WO2014111764A1 Combination of biological pesticides
Patent US20130190260 A1 Active agent combinations
Ahmad N et al, “Effects of neem based insecticides on Plutella xylostella (Linn.)” (2012) 34 Crop Protection 18-24.
Ahmed, K S et al, “Effects of plant oils on oviposition preference and larval survivorship of Callosobruchus chinensis on azuki bean” (1999) 34:4 Applied Entomology and Zoology 547-550.
Ankersmit, G W, “DDT resistance in Plutella maculipennis (Curt.) (Lepidoptera) in Java” (1953) 44 Bull. Entomol. Res. 421-25.
Bass C et al, “The evolution of insecticide resistance in the peach potato aphid, Myzus persicae” (2014) 51 Insect Biochem Mol Biol. 41-51.
Chidawanyika F et al, “Biologically Based Methods for Pest Management in Agriculture under Changing Climates: Challenges and Future Directions” (2012) 3 Insects 1171-1189.
Gahukar R T, “Formulations of neem based products/pesticides” (1996) 20(9) Pestology 44-45.
Gurusubramanian R S, “Bioefficacy of azadirachtin content of neem formulation against three major sucking pests of tea in Sub Himalayan tea plantation of North Bengal, India” (2011) 44:3 Agricultura Tropica Et Subtropica.
Hemingway J et al, “Insecticide resistance in insect vectors of human disease” (2000) 45 Annu. Rev. Entomol. 371-391.
Ilias A et al, “Global distribution and origin of target site insecticide resistance mutations in Tetranychus urticae” (2014) 48 Insect Biochemistry and Molecular Biology 17-28.
Jensen S E, “Insecticide Resistance in the Western Flower Thrips, Frankliniella occidentalis” (2000) 5(2) Integrated Pest Management Reviews 131-146.
Jetter K M et al, “The Silverleaf Whitefly Infestation in California In Private Investment in Exotic Pest Control Technology The Case of Silverleaf Whitefly in California” (2001) University of California Agricultural Issues Center 15-20.
Henneberry T J, Faust E D, eds. “Silverleaf Whitefly: National Research, Action, and Technology Transfer Plan, 1997-2001” Second Annual Review of the Second 5-Year Plan, Held in Albuquerque, N. Mex., Jan. 31-Feb. 2, 1999. U.S. Department of Agriculture, 195 pp.
Karaa\check{c}aç S U “Insecticide Resistance” In Insecticides—Advances in Integrated Pest Management, Dr. Farzana Perveen (Ed.) 2012; pp 469-478.
Mouatcho J C et al, “Pyrethroid resistance in a major African malaria vector Anopheles arabiensis from Mamfene, northern KwaZulu-Natal, South Africa” (2009) 105 South African Journal of Science 127-139. Ranson H et al, “Pyrethroid resistance in African Anopheline mosquitoes: what are the implications for malaria control?” (2011) 27 Trends Parasitol 91-98.
Roditakis E et al, “Insecticide resistance in Bemisia tabaci (Homoptera: Aleyrodidae) populations from Crete” (2005) 61(6) Pest Manag Sci. 577-82.
Rusch A et al, “Biological Control of Insect Pests in Agroecosystems: Effects of Crop Management, Farming Systems, and Seminatural Habitats at the Landscape Scale: A Review” In Advances in Agronomy (2010) 109 Elsevier Inc 219-259.
Silva A X et al, “Insecticide Resistance Mechanisms in the Green Peach Aphid Myzus persicae (Hemiptera: Aphididae) I: A Transcriptomic Survey” (2012) 7(6) PLoS ONE e36366. doi:10.1371/journal.pone.0036366
Schleier J J et al, “Pyrethrins and Pyrethroid” In Green Trends in Insect Control (2011) 11 Oscar Lopez and Jose G. Fernandez-Bolanos Ed. Royal Society of Chemistry 94-131.
Toe K H et al, “Increased Pyrethroid Resistance in Malaria Vectors and Decreased Bed Net Effectiveness, Burkina Faso” (2014) 20(10) Emerging Infectious Diseases 1691-1696.
Tozzi A “A Brief History of the Development of Piperonyl Butoxide as an Insecticide Synergist” In Piperonyl Butoxide: The Insecticide Synergist; Jones, D. G., Ed.; Academic: San Diego, Calif., 1998; pp 1-5.
Van Leeuwen T et al, “Acaricide resistance mechanisms in the two-spotted spider mite Tetranychus urticae and other important Acari: A review” (2010) 40(80) Insect Biochemistry and Molecular Biology 563-572.
WHO “Public health impact of pesticides used in agriculture. 1. Pesticides—adverse effects 2. Pesticides—poisoning” (1990) World Health Organization pp 128.

What is claimed is:

1. A pesticidal composition comprising a pesticidal natural fungal entomopathogen a pesticidal natural oil and a pesticidal botanical extract.

2. A pesticidal composition as defined in claim 1, wherein the pesticidal natural oil and pesticidal botanical extract and components thereof comprise cold pressed neem oil and refined pyrethrum extract.

3. A pesticidal composition as defined in any one of claims 1 to 2, wherein the cold pressed neem comprises any oil having as a major active constituent one or more of azadirachtin, nimbin, nimbinin and salannin.

4. A pesticidal composition as defined in any one of claims 1 to 3, wherein the refined pyrethrum extract comprises any extract having as a major active constituent one or more of pyrethrin I, pyrethrin II, cinerin I, cinerin II, jasmolin I, and jasmolin II, known to possess insecticidal activity.

5. A pesticidal composition as defined in any of claims 1 to 4, wherein the pesticidal natural oil constituents known to possess insecticidal activity are present at a percentage greater than or equal to 1%, 2%, 5% or 10% by weight in the pesticidal natural oil.

6. A pesticidal composition as defined in any of claims 1 to 5, wherein the pesticidal botanical extract constituents known to possess insecticidal activity are present at a percentage greater than or equal to 0.25%, 0.5%, 0.75% or 1.0% by weight in the pesticidal botanical extract.

7. A pesticidal composition as defined in any one of claims 1 to 6, wherein pesticidal natural fungal entomopathogen is selected from a group of: Aschersonia spp. Beauveria spp., Entomophthora spp., Hirsutella spp., Isaria spp., Lecanicillium spp., Metarhizium spp. Nomuraea spp., and Paecilomyces spp.

8. A pesticidal composition as defined in any one of claims 1 to 7, wherein pesticidal natural fungal entomopathogen comprises Beauveria bassiana strain GHA.

9. A pesticidal composition as defined in any one of claims 1 to 8, wherein the pesticidal natural oil comprises cold press neem oil, the pesticidal botanical extract comprises refined pyrethrum extract and the pesticidal natural fungal entomopathogen comprises Beauveria bassiana strain GHA.

10. A pesticidal composition as defined in any one of claims 1 to 9, comprising a surfactant.

11. A pesticidal composition as defined in claim 10, wherein the surfactant comprises ethoxylated alcohols, ethoxylated fatty esters, alkoxylated glycols, ethoxylated fatty acids, carboxylated alcohols, carboxylic acids, fatty acids, ethoxylated alkylphenols, fatty esters, sodium dodecylsulfide, other fatty acid-based surfactants, other natural or synthetic surfactants, or a combination thereof.

12. A pesticidal composition as defined in any one of claim 10 or 11, wherein the surfactant is present at a concentration of between 2% and 12% by weight, wherein the surfactant optionally comprises nonylphenol ethoxylate.

13. A pesticidal composition as defined in any one of claims 1 to 12, comprising a carrier, wherein the carrier optionally comprises mineral oil, present at a concentration of between 88% and 95% by weight.

14. A pesticidal composition as defined in claim 13, wherein the carrier comprises a mineral or vegetable oil.

15. A pesticidal composition as defined in any one of claims 1 to 14, wherein the pesticidal natural oil is present at a concentration of between 1% and 10% by weight, including any concentration there between, including 2%, 3%, 4%, 5%, 6%, 7%, 8%, or 9% by weight.

16. A pesticidal composition as defined in any one of claims 1 to 15, wherein the pesticidal botanical extract is present at a concentration of between 0.25% and 1.0% by weight, including any concentration there between, including 0.3%, 0.4%, 0.5%, 0.6%, 0.7%, 0.8%, or 0.9% by weight.

17. A pesticidal composition as defined in any one of claims 1 to 16, wherein the pesticidal natural fungal entomopathogen is present at a concentration of between 1×10⁶ and 1×10¹⁰ spores per ml, including any concentration there between, including 1×10⁶ and 1×10¹⁰ spores per ml.

28. A method for preparing an insecticidal composition, comprising mixing a pesticidal natural oil, a pesticidal botanical extract and a pesticidal natural fungal entomopathogen.

29. A method as defined in claim 28, wherein adding a surfactant comprises adding the surfactant to a final concentration of between 2% and 12% by weight to the carrier diluent that comprises an oil with a final concentration between 88% and 95% by weight, adding the pesticidal natural oil and pesticidal botanical extract to the liquid phase, and adding a pesticidal natural fungal entomopathogen to the final mixture.

18. A pesticidal composition as defined in any one of claims 1 to 17, wherein the pesticidal natural oil comprises cold pressed neem oil at a concentration of 2% to 10% by weight, wherein the pesticidal botanical extract comprises refined pyrethrum extract at a concentration of 0.25% to 0.75% by weight and wherein pesticidal natural fungal entomopathogen at a concentration of 1×10⁷ to 5×10⁸ spores per ml.

19. A pesticidal composition as defined in any one of claims 1 to 18, comprising a surfactant at a concentration of between about 8 to 12% by weight, wherein the surfactant optionally comprises nonylphenol ethoxylates.

20. A pesticidal composition as defined in any one of claims 1 to 19, comprising a carrier, wherein the carrier optionally comprises mineral oil.

21. A pesticidal composition as defined in claim 20, wherein the carrier is present at a concentration of between 88% and 95% by weight.

22. A pesticidal composition as defined in any one of claims 1 to 21, for use in preventing or eliminating pest infestations.

23. A pesticidal composition as defined in claim 22, wherein the pests comprise arthropods, that comprise insects and/or mites.

24. A pesticidal composition as defined in claim 23, wherein the arthropods comprise whiteflies, aphids, thrips, mites, psyllids, mealybugs, soft scales, leafhoppers and plant hoppers, weevils, plant bugs, borers, leaf-feeding insects, scarab and leaf-feeding beetles, and disease transmitting insects of the order Diptera and subclass Acarina.

25. A pesticidal composition as defined in any one of claims 22 to 24, wherein the pests are located in greenhouses, outdoors, or on agricultural land.

26. A pesticidal composition as defined in any one of claims 1 to 25, wherein the pesticidal composition is effective to kill and/or control pests and/or prevent or reduce eclosion of their eggs.

27. A pesticidal composition as defined in any one of claims 1 to 26, wherein the pesticidal composition exhibits effective knockdown pesticidal activity, and/or exhibits effective synergistic pesticidal activity.
